(19) United States
(12) Patent Application Publication
(10) Pub. No.: US 2003/0153443 A1
(43) Pub. Date: Aug. 14, 2003

(54) Elastic roller for a pressing apparatus

(76) Inventor: David A. Beck, Appleton, WI (US)

Correspondence Address: TAYLOR & AUST, P.C., 142 S. Main St., P.O. Box 560, Avilla, IN, 46710, US

(21) Appl. No.: 10/073,479

(22) Filed: Feb. 11, 2002

(51) Int. Cl. B25F 5/02; F16C 13/00

(52) U.S. Cl. 492/56; 29/895

(57) ABSTRACT

A method for making an elastic roller for a pressing apparatus comprising a plurality of rollers to define at least one chamber therebetween comprises the step of: providing at least one cavity below the roller surface of said elastic roller in the region of at least one roller end for cooperation with at least one raised portion provided on said elastic roller in the region of the roller end or on a counter roller of said pressing apparatus.

The present invention relates to a method for making an elastic roller for a pressing apparatus comprising a plurality of rollers to define at least one chamber therebetween. The invention further relates to an elastic roller for such a pressing apparatus. Finally, the present invention relates to a pressing apparatus including at least one elastic roller.

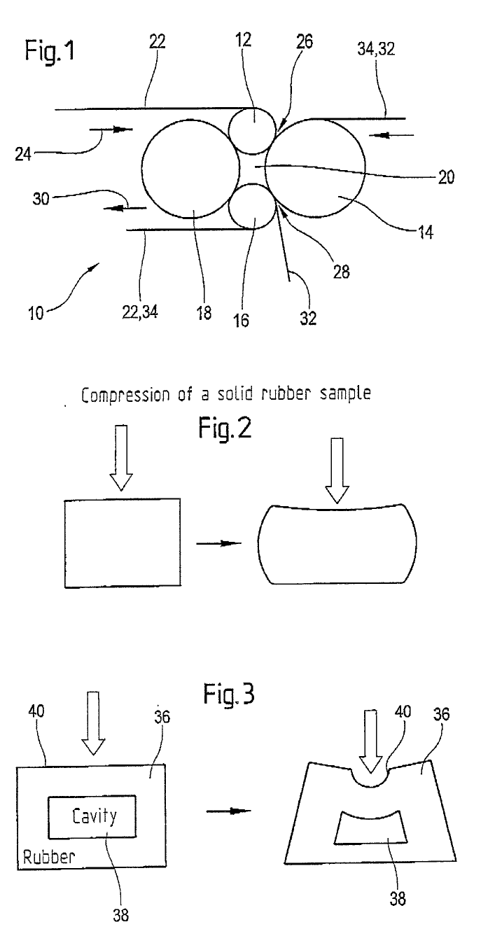

For some years attempts have been made to develop a new method for removing water from paper. The new method envisaged was to use compressed air to displace water from a sheet of paper. It was envisaged that a cluster of e.g. four rollers could be used to create an enclosed area that would be sealed by the four nips formed by the rollers as shown, for example, in FIG. 1. If the ends of the four rollers could be sealed off, the space between the rollers could be pressurized and this could create unique wrap processing conditions.

FIG. 1 is a schematic side view of an example of such a pressing apparatus 10 which is particularly useful in paper making. The pressing apparatus 10 comprises a plurality of rollers to define at least one chamber. In the present exemplary embodiment four rollers 12, 14, 16, 18 are provided to define one chamber 20. For convenience, sometimes rollers 14, 18 will be refereed to as main rollers and rollers 12, 16 will be referred to as cap rollers.

The rollers 12, 14, 16, 18 can be closed hollow cylinders. In the present exemplary embodiment roller 14 is a vented main roller.

As shown in FIG. 1, a membrane 22 travels in the direction of arrow 24 and is routed over a portion of the circumferential surface of cap roller 12, passes into inlet roller nip 26, passes over a portion of the circumferential surface of vented main roller 14 within chamber 20, passes out of outlet roller nip 28, passes over a portion of the circumferential surface of cap roller 16, and travels in the direction of arrow 30. Between the membrane 22 and the vented main roller 14, a felt 32 and the sheet 34 pass over the mentioned portion of the circumferential surface of the vented main roller 14, with the sheet 34 being disposed between the membrane 22 and the felt 32. Behind the outlet roller nip 28, in the region of cap roller 16, the felt 32 is separated from the sheet 34 which then travels together with the membrane 22 in the direction of arrow 30.

The Advantages of such a configuration and its uses are many, but briefly, the rolling nips allow for a web to be passed into a pressurized area. The nips in this arrangement all turn at similar surface speeds, so that the seal created by these nips do not wear appreciatively and the web itself is not disrupted as it passes into the pressure zone. Once in the pressure zone, the web is acted upon by whatever medium that is inside the pressure zone. The pressure and speed of the system can control the needs of the process.

In general, more than four rollers could be provided and more than one chamber could be defined by these rollers.

To be able to pressurize the respective roller cluster, it is vital that there is a good seal on the ends of the rollers. The seal should have low leak rates. Furthermore, it must operate under the changing pressure within the chamber formed by the respective roller cluster.

Thus, in such a pressing apparatus the press rollers are forced together to form the chamber which must be sealed at the roll ends so that the chamber can be pressurized. However, if elastic or rubber rolls are used in the cluster press, a bulge may develop on the ends of the rollers, and this bulge makes it impossible to seal in this area.

Normally, when a rubber piece is compressed, the rubber extrudes out of the side edges, as shown in FIG. 2. The amount of extrusion is described by the Poisson ratio.

In this case the edges become further apart, which in the case of a roller, leads to a roller edge that is not flat. Furthermore, because of this Poisson effect, the edge changes shape as the press load is changed. Such a variation in edge shape, however, is a detriment to sealing.

Accordingly, a need exists for an improved elastic roller which can be used in a pressing apparatus of the above-referenced kind without involving any bulges on the ends of the roll, so that the chamber of the roller cluster can be closed off by a corresponding sealing arrangement without leakage.

According to the invention, this object is achieved by the method for making an elastic roller, the elastic roller and the pressing apparatus as defined in the claims.

The present invention provides a method for making an elastic roller for a pressing apparatus comprising a plurality of rollers to define at least one chamber therebetween, said method comprising the step of providing at least one cavity below the roller surface of said elastic roller in the region of at least one roller end for cooperation with at least one raised portion provided on said elastic roller in the region of the roller end or on a counter roller of said pressing apparatus.

With the special elastic roller construction achieved by this method the occurrence of detrimental bulges is avoided. When the elastic roller is loaded by pressing a counter roller into the elastic roller, the end roller face remains flat and matches the face edge of the counter roller in the area where they meet. Thus, a seal can be put across the counter roller and the elastic roller.

The cavity, the raised portion, the pressure in the cavity, and/or the shape of the edge of the roller can be designed or controlled so that, for at least over a given range of press loads, the roller end surface is at least essentially kept flat in respect of the press loads, Thus, the roller edge will remain vertical and keep its shape, if the cavity and the raised portion are designed properly.

In order to keep a flat edge, the roller end should come up with an effect that counter-acts the Poisson effect, and exactly balances it on the end face of the roller. That is, when the new structure is compressed, the structure must react by reducing its width by the same amount that the width would have increased by the Poisson effect.

In accordance with a preferred embodiment the cavity is constructed in the shape of a circumferential ring.

The cavity is preferably provided just below the roller surface.

The raised portion, too, can be in the shape of a circumferential ring mating with the circumferential cavity.

In accordance with a preferred embodiment of the method according to the present invention at least one of the following design variables can be used for keeping the roller end surface flat: the size of said cavity, the shape of said cavity, the size of said raised portion, the shape of said raised portion, the location of said cavity in said elastic roller, the location of said cavity relative to said raised portion, the composition of the elastic roller material, the pressure of the cavity, and the shape of the edge of the roller.

The raised portion can be provided over the center of the cavity or off center from this cavity.

One particularly interesting possibility is to vary the location and shape of the raised portion or area relative to the cavity underneath. If more tilt in was needed at low press loads, the raised portion should be located over the center of the cavity. This will cause the most tilt in at low pressures, with the tilt in becoming less and less, as the raised portion reaches the flat state. If the raised portion is located off center from the cavity, the tilt in will be delayed as pressure increases. The depth of the cavity below the roller surface, e.g., can also be a factor in determining the tilt in response.

A Finite Element Analysis can be used for defining the respective elastic roller parameters and all the other parameters necessary to maintain a flat roller edge.

The elastic roller is preferably a rubber roller.

The present invention further provides an elastic roller for a pressing apparatus comprising a plurality of rollers to define at least one chamber therebetween, wherein said elastic roller comprises at least one cavity below its surface in the region of at least one of its ends for cooperation with at least one raised portion provided on said elastic roller in the region of the roller end or on a counter roller.

Preferred embodiments of the elastic roller according to the present invention are given in the subordinate claims.

The present invention further provides a pressing apparatus comprising a plurality of rollers to define at least one chamber therebetween, at least one of said rollers being an elastic roller, wherein said elastic roller comprises at least one cavity below its surface in the region of at least one of its ends for cooperation with at least one raised portion provided on said elastic roller in the region of the roller end or on a counter roller.

Preferred embodiments of the pressing apparatus in accordance with the invention are given in the subordinate claims.

Having regard to advantageous developments of the invention, reference should be made to the subordinate claims and also to the subsequent description of embodiments of the invention, with reference to the accompanying drawings, wherein:

FIG. 1 is a schematic side view of an example for a pressing apparatus which comprises a plurality of rollers defining a chamber;

FIG. 2 is a diagram illustrating the possible results of a compression of a solid rubber sample; and

FIG. 3 a diagram illustrating the behaviour of a rubber sample comprising a cavity in response to compression.

In connection with the roller edge compensation according to the present invention a rubber roller is provided that does not bulge when it is loaded. That is, when a steel roller is pressed into this rubber roller, the end roller face must remain flat and match the face edge of the steel roller in the area where they meet, so that a seal can be put across the steel roller and the rubber roller.

Accordingly, a structure is designed that keeps a flat edge, for a range of press loads. The edge will remain vertical and keep its shape, if the roll end is designed properly.

In order to keep a flat edge, an effect should be achieved that counter-acts the Poisson effect, and exactly balances it on the end face of the roller. That is, when the new structure is compressed, the structure must react be reducing its width by the same amount that the width would have increased by the Poisson effect.

FIG. 3 shows a diagram illustrating the behaviour of a rubber sample or piece 36 having a cavity 38 in response to compression. To simplify matters, the appliance of a point load to the piece of rubber 36 is considered.

If the load is applied over the cavity 38 in the rubber, the load will cause the rubber to bend into the cavity 38. As the rubber 36 bends into the cavity 38, tension will be generated in the rubber surface 40, causing the edges of the rubber 36 to tilt inward.

In this diagram according to FIG. 3, if we look at a horizontal layer of rubber at the surface 40 of the rubber piece 36 on the left, it is noted that it has a particular length. At the same layer of rubber on the right block or piece of rubber 36, it can be seen that the applied load is acting to increase this length. This increase causes tension to build in the surface layer, and also causes the side of the rubber to tilt inward. The cavity 38 underneath facilitates the bending of the horizontal layer, and thus enhances the tilt in effect although it will happen to a lesser extent without the cavity 38.

By shaping the cavity, varying the applied load, and/or the topography of the applied load, the tilt in effect can be controlled.

This can now be applied to a rubber roller for a pressing apparatus comprising a plurality of rollers to define at least one chamber therebetween.

When a steel roller and rubber roller are engaged to form a nip, near the edges of the rubber roller, there would normally be a bulge, due to the facts shown in FIG. 2 and described above, But if a rubber roller is constructed with a cavity 38 in it, the bulge can be controlled. The cavity can be constructed in the shape of a circumferential ring, near the end of the roller, and can be located just below the roller surface. Mating with this ring there could be a raised circumferential ring on the steel roller or on the rubber roller.

When the steel roller and rubber roller are pressed together, the raised ring on, e.g., the steel roller would apply a higher force in the area of the cavity, and thus it would cause bending in the rubber roller surface, This bending would put tension in the surface layers of the roller, and this tension would offset the Poisson effect. If the cavity and raised ring or ridge were designed properly, the rubber position could remain stationary at the roll end, allowing the seal to make intimate contact.

There are many design possibilities that could be used to make this work, A few examples are mentioned below:

To keep the roller end surface flat over a large range of press loads, it is necessary to balance Poisson's expansion over a large range of press loads. The shape of the steel mating ring, the size and shape of the cavity, the location of the cavity and the relative location of the raised area over the cavity are some of the design variables that can be varied to make the response flat over a range of operating conditions. Rubber composition can also be varied.

Instead of having a raised area on the steel roller that presses into the cavity, it is possible to have the raised area on the rubber roller. This may be more practical then putting the raised area on the steel roller, since by locating the raised area on the rubber, it is assured that it is in the correct position relative to the cavity. Furthermore, rubber rollers are more easily covered and ground, than steel rollers. And finally, since the size and shape of this raised area are dependent on the cavity used in the rubber roller, it makes more sense to match the cavity and raised area on the same structure.

As already mentioned above, one particularly interesting possibility is to vary the location and shape of the raised area relative the cavity underneath. If more tilt in was needed at low press loads, the raised area should be located over the center of the cavity. This will cause the most tilt in at low pressures, with the tilt in becoming less and less, as the raised area reaches the flat state. If the raised area is located off center from the cavity, the tilt in will be delayed as pressure increases. Of course the depth of the cavity below the roll surface is also a factor in determining the tilt in response.

A Finite Element Analysis can be used for defining the respective elastic roller parameters and all other parameters taken into account to keep the roller end surface flat.

Thus, the basic idea is to include a cavity in the press roll, which adsorbs the bulge as the rolls are pressed together. The control of this bulge is critical to sealing on the ends of the rolls.

However, in practical use in a so-called Beck-Cluster Press (cf. FIG. 1), the bulge is created by two forces. In addition to the nip load, the other force is the air pressure in the chamber. The air pressure also causes a bulge, which is actually greater than the bulge caused by the press rolls being forced together. The air pressure bulge force is caused by the pressure difference between the chamber, and atmospheric pressure.

In practice, the contact force between the four press rolls only needs to be small to make a seal. That is, only contact between the rolls is needed to seal the chamber. In fact, to maintain sheet bulk, the contact force should be as little as possible, since roll contact force reduces sheet bulk. So ideally, the press roll force needs to balance the chamber air pressure, and provide a slight positive pressure to maintain contact at the nip. One of the major challenges of building a wide press will be challenge of maintaining low contact force across the width of the press roll in the face of changing chamber pressure and roll deflections.

That means that the cavity will be acted upon by the chamber pressure. The force on the cavity will depend on the pressure gradiant between the chamber and the roll cavity. This force can act to control the bulge in the seal area. The bulge can be controlled by varying the shape, position, and volume of the cavity, but it may also be controlled by varying the pressure in the cavity. That is, the cavity can be vented to atmosphere, or be statically pressurized, or it can be set to a controlled pressure. Furthermore, the bulge could be controlled by the shape of the external ridge pressing on the cavity—in concert with the air pressure in the cavity.

If one looks at the pressurization of the cavity a little closer, one can see that this is also an effective means to counteract wear on the roll edge. That is, as the roll edge wears out, it will be necessary to create a bulge to maintain a flat surface in the seal area. By pressurizing the cavity, one can do this exactly as needed.

Finally, another area to consider is the shape of the roll end as it affects the bulge. Another way to counteract or control the bulge is to shape the edge of the roll, so that a flat surface is created when a bulge occurs. For a given roll edge shape, there would only be one condition load condition that would give a flat surface. However, the roll end shape in conjunction with the cavity, shape, volume, etc. could be designed to get a flat surface under a range of conditions. Thus roll end shape is another factor which could be considered as a parameter for roll design.

### List of Reference Numerals

10 pressing apparatus

12 roller, cap roller

14 roller, vented main roller

16 roller, cap roller

18 roller, main roller

20 chamber

22 membrane

24 arrow

26 inlet roller nip

28 outlet roller nip

30 arrow

32 felt

34 sheet

36 rubber sample

38 cavity

40 rubber surface

1. A method for making an elastic roller for a pressing apparatus comprising a plurality of rollers to define at least one chamber therebetween, said method comprising the step of:
providing at least one cavity below the roller surface of said elastic roller in the region of at least one roller end for cooperation with at least one raised portion provided on said elastic roller in the region of the roller end or on a counter roller of said pressing apparatus.

2. The method of claim 1, further comprising the step of designing or controlling said cavity, said raised portion, the pressure in the cavity, and/or the shape of the edge of the roller so that, for at least over a given range of press loads, the roller end surface is at least essentially kept flat irrespective of the press load.

3. The method of claim 1 or 2, further comprising the step of constructing said cavity in the shape of a circumferential ring.

4. The method of any one of the preceding claims, further comprising the step of providing said cavity just below the roller surface.

5. The method of any one of the preceding claims, further comprising the step of providing said raised portion in the shape of a circumferential ring.

6. The method of any one of the preceding claims, further comprising the step of using at least one of the following design variables for keeping the roller end surface flat: the size of said cavity, the shape of said cavity, the size of said raised portion, the shape of said raised portion, the location of said cavity in said elastic roller, the location of said cavity relative to said raised portion, the composition of the elastic roller material, the pressure in the cavity, and the shape of the edge of the roller.

7. The method of any one of the preceding claims, further comprising the step of providing said raised portion over the center of said cavity.

8. The method of any one of the claims 1 to 6, further comprising the step of providing said raised portion off center from said cavity.

9. The method of any one of the preceding claims, further comprising the step of using a Finite Element Analysis for defining the respective elastic roller parameters.

10. The method of any one of the preceding claims, wherein said elastic roller is a rubber roller.

11. An elastic roller for a pressing apparatus comprising a plurality of rollers to define at least one chamber therebetween, wherein said elastic roller comprises at least one cavity below its surface in the region of at least one of its ends for cooperation with at least one raised portion provided on said elastic roller in the region of the roller end or on a counter roller.

12. The elastic roller of claim 11, wherein said cavity, said raised portion, the pressure in the cavity, and/or the shape of the edge of the roller are designed or controlled so that, for at least over a given range of press loads, the roller end surface is at least essentially kept flat irrespective of the press load.

13. The elastic roller of claim 11 or 12, wherein said cavity is constructed in the shape of a circumferential ring.

14. The elastic roller of any one of the preceding claims, wherein said cavity is disposed just below the roller surface.

15. The elastic roller of any one of the preceding claims, wherein said raised portion is provided in the shape of a circumferential ring.

16. The elastic roller of any one of the preceding claims, wherein said raised portion is provided over the center of said cavity.

17. The elastic roller of any one of the claims 11 to 15, wherein said raised portion is provided off center from said cavity.

18. The elastic roller of any one of the preceding claims, wherein the end of said elastic roller is closed off by a sealing arrangement.

19. The elastic roller of any one of the preceding claims, wherein said elastic roller is a rubber roller.

20. A pressing apparatus comprising a plurality of rollers to define at least one chamber therebetween, at least one of said rollers being an elastic roller, wherein said elastic roller comprises at least one cavity below its surface in the region of at least one of its ends for cooperation with at least one raised portion provided on said elastic roller in the region of the roller end or on a counter roller.

21. The pressing apparatus of claim 20, wherein said cavity, said raised portion, the pressure in the cavity, and/or the shape of the edge of the roller are designed or controlled so that, for at least over a given range of press loads, the roller end surface is at least essentially kept flat irrespective of the press load.

22. The pressing apparatus of claim 20 or 21, wherein said cavity is constructed in the shape of a circumferential ring.

23. The pressing apparatus of any one of the preceding claims, wherein said cavity is disposed just below the roller surface.

24. The pressing apparatus of any one of the preceding claims, wherein said raised portion is provided in the shape of a circumferential ring.

25. The pressing apparatus of any one of the preceding claims, wherein said raised portion is provided over the center of said cavity.

26. The pressing apparatus of any one of the claims 20 to 24, wherein said raised portion is provided off center from said cavity.

27. The pressing apparatus of any one of the preceding claims, wherein the end of said elastic roller is closed off by a sealing arrangement.

28. The pressing apparatus of any one of the preceding claims, wherein said elastic roller is a rubber roller.

29. The pressing apparatus of any one of the preceding claims, wherein said counter roller is a steel roller.
